(19) United States
(12) Patent Application Publication
(10) Pub. No.: US 2026/0249719 A1
(43) Pub. Date: Aug. 27, 2026

(54) DC FAST-CHARGING BIDIRECTIONAL CONVERTER UTILIZING DELTA MOTOR AND INVERTER

(71) Applicant: MAGNA POWERTRAIN OF AMERICA, INC., Troy, MI (US)

(72) Inventors: Hassan SHABBIR, Dearborn, MI (US); Aminesh GAJJAR, South Lyon, MI (US); Patrick LAMPLMAYR, St. Georgen (AT)

(21) Appl. No.: 19/163,284

(22) PCT Filed: Mar. 14, 2024
(86) PCT No.: PCT/US2024/019861

§ 371 Date: Sep. 8, 2025

Related U.S. Application Data
(60) Provisional application No. 63/456,213, filed on Mar. 31, 2023.

(51) Int. Cl. B60L 53/22; B60L 53/14; B60L 53/24

(52) U.S. Cl. CPC B60L 53/22; B60L 53/14; B60L 53/24; B60L 2210/12; B60L 2210/14

(57) ABSTRACT

An electrical system includes an energy storage device; a traction motor having a delta configuration; and an inverter connected to the energy storage device for receiving direct current (DC) power therefrom. The inverter includes a plurality of pairs of semiconductor switches, each pair of semiconductor switches is configured to apply an alternating current (AC) power to a corresponding winding node of the traction motor. The electrical system also includes an external power source, and a mode control switch connected between a positive terminal of the external power source and a given winding node of the traction motor. The mode control switch is operable in a closed state to allow current flow therethrough, and the mode control switch is operable in an open state to prevent current flow between the external power source and the given winding node.

### CROSS REFERENCE TO RELATED APPLICATIONS

This PCT international patent application claims the benefit of U.S. Provisional Patent Application No. 63/456,213, filed Mar. 31, 2023, the contents of which is incorporated herein by reference in its entirety.

### FIELD OF THE INVENTION

The present invention relates to bidirectional voltage converter utilizing vehicle power electronics and phase windings in an electric vehicle's traction motor in a delta winding configuration. The electrical system allows a vehicle charger of a lower voltage to be utilized by an electric vehicle with a higher voltage energy storage device in a boost mode, as well as providing the ability to reduce voltage from a higher voltage energy storage device to an external battery with a lower voltage in a buck mode. The system proposed only requires a single switch in the architecture to transition from motor mode to charging mode, eliminating the cost and complications of controlling multiple switches.

### BACKGROUND OF THE INVENTION

This section provides background information related to the present disclosure which is not necessarily prior art.

Electric vehicles utilize charging systems to replenish energy storage devices within the vehicle after a period of operation. Electrical power is supplied by an external source and electrical componentry is utilized to convert the power into a state suitable for to be received to return the energy storage device to a recharged state.

There is currently a push for electric vehicles which operate at a higher nominal battery supply voltage than current electrical vehicle recharging facilities provide. Electric vehicle chargers typically provide only a voltage of 400 V, while the latest battery nominal voltages are 800 V or higher. Therefore, there is a need to provide a way to charge the electric vehicles with 800V or higher energy storage devices with the recharging facilities which supply lower voltages in an efficient and time effective manner. Utilizing and adding a traditional boost converter could be included in these newer higher voltage electric vehicles, but this adds cost, expense and requires space in the vehicle. Therefore, utilizing a traditional boost converter in a vehicle is not an effective solution. A solution modifying and utilizing the base electrical componentry already existing in the electric vehicle to create a bi-directional converter will be described. Using power traction inverter along with primary motor in addition with application specific external electronics can allow the recharger to convert the energy stored in the energy storage device in the vehicle in more efficient way such that the power can delivered to vehicle at a faster rate. The revised electrical componentry can function as a boost or a buck converter depending on the operational modes of various switches to provide either an increased voltage output from an external DC charger or a reduced voltage output to an off-board energy storage device.

### SUMMARY

This section provides a general summary of the many aspects associated with the inventive concepts embodied in the teachings of the present disclosure and is not intended to be considered a complete listing of its full scope of protection nor all of its features and advantages.

In accordance with an aspect of the present disclosure, an electrical system is provided. The electrical system includes an energy storage device defining a first positive terminal and a first negative terminal and having a first voltage therebetween. The electrical system also includes a traction motor having a plurality of machine windings in a delta configuration and defining a first winding node, a second winding node, and a third winding node. The electrical system also includes an inverter connected to the energy storage device for receiving direct current (DC) power therefrom, the inverter including a plurality of pairs of semiconductor switches, each pair of semiconductor switches of the plurality of pairs of semiconductor switches being configured to apply an alternating current (AC) power to a corresponding one of the first winding node, the second winding node, and the third winding node. The electrical system also includes an external power source defining a second positive terminal and a second negative terminal and having a second voltage therebetween; and a mode control switch connected between the second positive terminal of the external power source and a given winding node of the first winding node, the second winding node, and the third winding node, wherein the mode control switch is operable in a closed state to allow current flow therethrough, and wherein the mode control switch is operable in an open state to prevent current flow between the external power source and the given winding node.

In accordance with an aspect of the present disclosure, a method of operating an electrical system is provided. The method includes: providing an energy storage device defining a first positive terminal and a first negative terminal and having a first voltage therebetween, a traction motor having a plurality of machine windings in a delta configuration and defining a first winding node, a second winding node, and a third winding node, an inverter including a plurality of pairs of semiconductor switches, and an external power source defining a second positive terminal and a second negative terminal and having a second voltage therebetween; applying, by each pair of semiconductor switches of the plurality of pairs of semiconductor switches, an alternating current (AC) power to a corresponding one of the first winding node, the second winding node, and the third winding node, and using direct current (DC) power from the energy storage device; selectively conducting, by a mode control switch, current between the second positive terminal of the external power source and a given winding node of the first winding node, the second winding node, and the third winding node for operating the electrical system in a power converter mode for transferring power between the energy storage device and the external power source; and selectively blocking, by the mode control switch, current between the second positive terminal of the external power source and the given winding node for operating the traction motor in a torque producing mode.

These and other features and advantages of the present invention will become more readily appreciated when considered in connection with the following detailed description and appending drawings.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1 of an electrical system in accordance with the present disclosure;

FIG. 2 shows a circuit schematic of the electrical system, in accordance with the present disclosure;

FIG. 3 shows the circuit schematic of FIG. 2, with arrows indicating current flow therethrough while operating in a first boost mode;

FIG. 4 shows the circuit schematic of FIG. 2, with arrows indicating current flow therethrough while operating in a second boost mode;

FIG. 5 shows the circuit schematic of FIG. 2, with arrows indicating current flow therethrough while operating in a first buck mode;

FIG. 6 shows the circuit schematic of FIG. 2, with arrows indicating current flow therethrough while operating in a second buck mode; and

FIG. 7 shows a flow chart illustrating steps in a method of operating an electrical system, in accordance with the present disclosure.

### DESCRIPTION OF THE ENABLING EMBODIMENTS

The following description of the electrical system and its usage is only exemplary in nature and is not intended to limit the present disclosure. As most current electric vehicle chargers provide only a voltage of 400 V, electric vehicles with 800V or higher energy storage devices often utilize a traditional boost converter. A solution modifying and utilizing the base electrical componentry already existing in the electric vehicle to create a boost converter will be described. Using the existing vehicles power traction inverter along with a traction motor in addition with application specific external electronics can allow the recharger to convert the energy stored in the energy storage device in the vehicle in more efficient way.

The present disclosure provides an example of the boost converter electrical system reutilizing the vehicle's electrical componentry. The complete electrical system may include a rechargeable energy storage device with an inverter connected to the energy storage device and provides converted electrical energy to the traction motor of the electric vehicle during normal operation of the electric vehicle. The modified electrical system is also capable of operating in a manner to supply a recharging voltage to the energy storage device after boosting the recharging voltage using an inductor of the traction motor and controlling switching elements of an inverter circuit. Specifically, a plurality of machine or motor windings of the traction motor can be utilized, connected between the inverter and the external recharging power source in combination with additional switches. In this arrangement the traction motor will be a three phase wound in the delta configuration. The delta configuration motor will have a lower resistance, a lower torque constant and operate at a higher current than star/WYE configurations which can be beneficial in some traction motor applications.

The same electrical system, with a revised scheme of controlling the switching elements of the inverter circuit, can operate as a forward buck converter. In this mode, the energy storage device operating at a higher voltage can provide a reduced voltage to an external energy storage device.

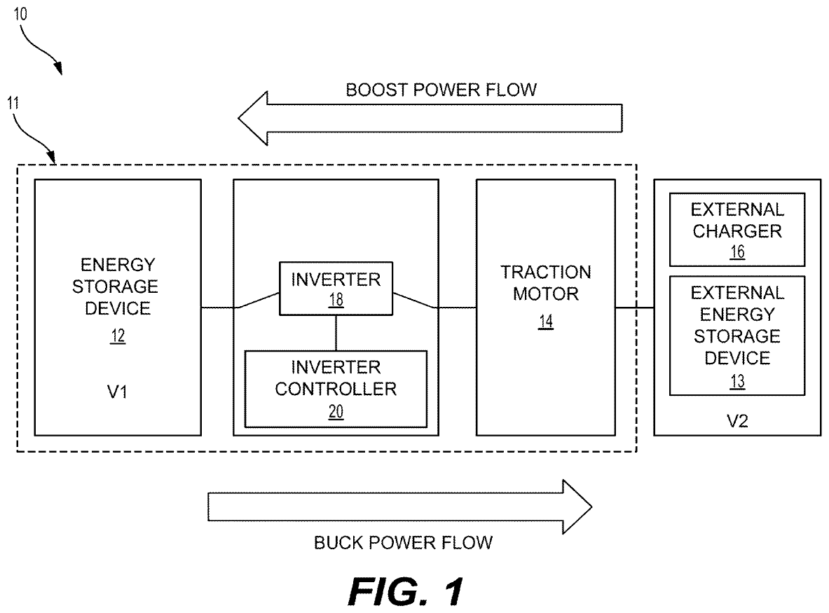

FIG. 1 shows a block diagram of the proposed electrical system 10. The electrical system 10 of the present disclosure may be used a vehicle 11, such as a passenger car or truck, which may be configured as an electric vehicle (EV) and/or a plug-in hybrid electric vehicle (PHEVs). An onboard energy storage device 12 is located on or within the vehicle 11 and stores electrical energy to provide power to the electrical system 10. The onboard energy storage device 12 may include a high voltage device which may be constructed of a multitude of individual battery packs arranged to provide direct current (DC) power output at a first voltage V1. The onboard energy storage device 12 may include electrochemical cells with lithium ion, NiMH, zinc air, or any other chemistry. As there are operational electrical load on the electric vehicles including power draw from a traction motor 14 which propels the electric or hybrid vehicle, the onboard energy storage device 12 must be replenished with energy after a period of operation.

The vehicle 11 and its onboard energy storage device 12 may be connected to an external power source 13, 16, which may have a second voltage V2 that is substantially lower than the first voltage V1 of the onboard energy storage device 12. The external power source 13, 16 may include an external charger 16, which may also be called an external charging system. The external charger 16 can apply, as an example, the second voltage V2 of 400 VDC, while the onboard energy storage device 12 operates at the first voltage V1, which can be 800 VDC or higher. To utilize the lower voltage output of a 400V external charger 16, the second voltage V2 must be increased, or stepped up. Such voltage boosting may be performed utilizing a traditional standalone boost converter or using the electrical system 10 of the present disclosure.

Additionally or alternatively, there can be a need to utilize the power within the onboard energy storage device 12 to provide power to an external energy storage device 13, which may also be called an off-board energy storage device, located outside of the vehicle 11 and operating at the second voltage V2 that is substantially less than the first voltage V1 of the onboard energy storage device 12. The external energy storage device 13 may include, for example, an energy storage device of a second electric vehicle or an external DC load. The connection to the external energy storage device 13 may be implemented only when the vehicle 11 is parked. In this situation the electrical system 10 of the present disclosure can operate as a forward buck converter decreasing the output voltage below the first voltage V1 voltage of 800V. Different values for either or both of the first voltage V1 and/or the second voltage V2 can also be utilized and the values provided are examples.

Continuing to refer to FIG. 1, the circuit connections and components of electrical system 10 including the onboard energy storage device 12, inverter 18, inverter controller 20, traction motor 14 and various electrical components which will be further described reside within the electric vehicle. In the boost mode, the external power source 13, 16 will provide a replenishing DC power source having the second voltage V2. The external power source 13, 16 may include an external charger 16, such as a typical DC fast charging system and/or another electric vehicle in a vehicle-to-vehicle recharging power transfer. The external power source 13, 16 will operate or provide a second voltage V2 which is lower than the first voltage V1 of the onboard energy storage device 12. The electrical system 10 described is not limited if the external DC voltage source is provided via a charging cable or if it is provided via a wireless power transfer. In buck mode, the second voltage V2 will be represented by an external energy storage device 13. Inverter 18 is the electrical device that converts electricity derived from a Direct Current (DC) source, in this case from the onboard energy storage device 12, to Alternating Current (AC), which powers a traction motor 14.

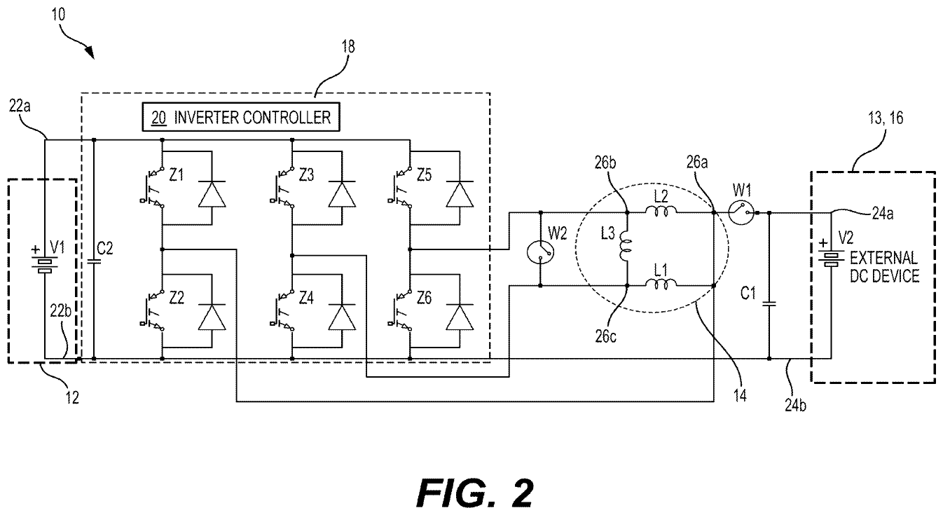

FIG. 2 shows a circuit schematic of the electrical system 10 of the present disclosure, and which includes the onboard energy storage device 12, the external power source 13, 16, and circuitry for transferring power in either direction therebetween. The onboard energy storage device 12 defines a first positive terminal 22a and a first negative terminal 22b, having the first voltage V1 therebetween. The external power source 13, 16 defines a second positive terminal 24a and a second negative terminal 24b, having the second voltage V2 therebetween.

The electrical system 10 of the present disclosure also includes the traction motor 14 and the inverter 18. The traction motor 14 includes a plurality of machine windings L1, L2, L3 in a delta configuration. A delta configuration has windings joined together at three winding nodes 26a, 26b, 26c. Windings L1 and L2 connect to define a first winding node 26a, machine windings L2 and L3 connect to define a second winding node 26b, and machine windings L3 and L1 connect to define a third winding node 26c. No neutral point exists in a delta configuration motor. During vehicle operation, a three-phase current is conducted in the machine windings L1, L2, and L3 to create a rotating magnetic field for operating the traction motor 14 in a torque producing mode.

The inverter 18 is connected to the onboard energy storage device 12, via the first terminals 22a, 22b, for receiving direct current (DC) power therefrom. The inverter 18 may be operated as a bidirectional DC-to-AC and AC-to-DC power converter. The inverter 18 includes a set of semiconductor switches (Z1-Z6) utilized to induce an alternating current of electricity provided to traction motor 14 via high frequency switching during vehicle operation. Each semiconductor switch Z1 through Z6 may be embodied as a voltage-controlled switching device in the form of a silicon insulated gate bipolar transistor (IGBT), a silicon carbide (SiC) metal-oxide semiconductor field effect transistor (MOSFET), a Gallium nitride (GaN) field-effect transistor (FET), or other suitable switch having a corresponding gate to which a gate signal is applied to change the on/off state of a given switch. There may be at least one pair of semiconductor switches for each phase of the three-phase traction motor 14.

The inverter 18, as shown in FIG. 2, includes a plurality of pairs of semiconductor switches Z1, Z2, Z3, Z4, and Z5, Z6. The pairs of the semiconductor switches include a first pair of switches Z1, Z2 that is configured to apply an alternating current (AC) power to the first winding node 26a. The pairs of the semiconductor switches also include a second pair of switches Z3, Z4 that is configured to apply AC power to the second winding node 26b. The pairs of the semiconductor switches also include a third pair of switches Z5,Z6 that is configured to apply AC power to the third winding node 26c.

The inverter 18 also includes inverter controller 20 which controls operation of the semiconductor switches Z1-Z6 by supplying a control signal to one or more gates to cause the semiconductor switches to transition between an open state and a closed state.

In some embodiments, and as show in FIG. 2, an input capacitor C1 may be connected between the second positive terminal 24a and the second negative terminal 24b of the external power source 13, 16, for smoothing a ripple in the second voltage V2. In some embodiments, and as show in FIG. 2, a DC link capacitor C2 may be connected between the first positive terminal 22a and the first negative terminal 22b of the onboard energy storage device 12 for stabilizing the first voltage V1 and providing inrush current as the semiconductor switches Z1-Z6 of the inverter 18 are operated.

Still referring to FIG. 2, the electrical system 10 also includes a mode control switch W1 connected between the second positive terminal 24a of the external power source 13, 16 and a given winding node of the traction motor 14. In some embodiments, and as shown in FIG. 2, the given winding mode is the first winding node 26a. However, the given winding node could alternatively be the second winding node 26b or the third winding node 26c. The mode control switch W1 may include a relay-type switch, although other types of switches may be used. The mode control switch WI is operable in a closed state to allow current flow therethrough, between the second positive terminal 24a of the external power source 13, 16 and the given winding node of the traction motor 14 for operating the electrical system 10 in in a power converter mode for transferring power between the onboard energy storage device 12 and the external power source 13, 16. The mode control switch W1 is also operable in an open state to prevent current flow between the second positive terminal 24a of the external power source 13, 16 and the given winding node of the traction motor 14 for operating the electrical system 10 with the traction motor 14 in a torque producing mode.

In some embodiments, and as also shown in FIG, 2, the electrical system 10 also includes a phase balancing switch W2 configured to selectively conduct current between two additional winding nodes of the traction motor 14. The two additional winding nodes include ones of the winding nodes 26a, 26b, 26c that are not the given winding node that is connected to the mode control switch W1. Where the given winding node is the first winding node 26a, as shown in FIG. 2, the two additional winding nodes include the second winding node 26b and the third winding node 26c.

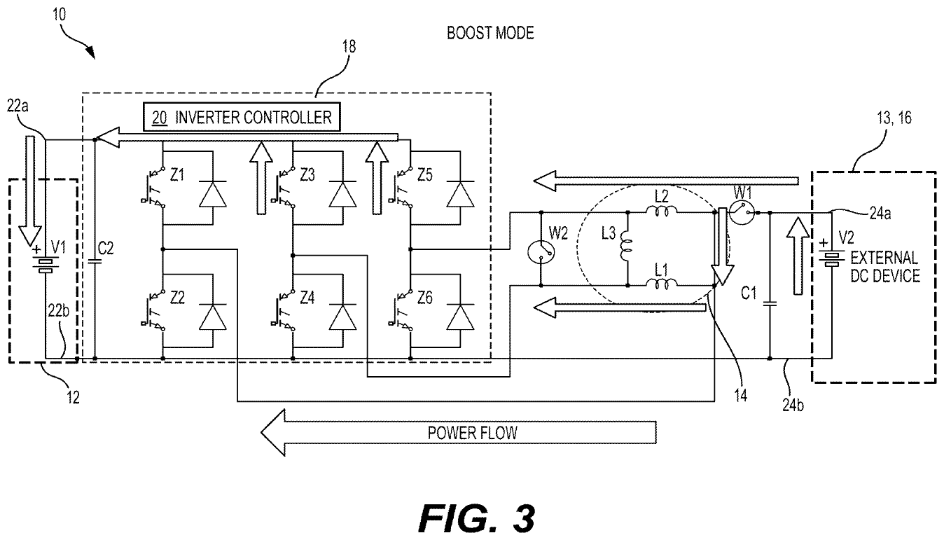

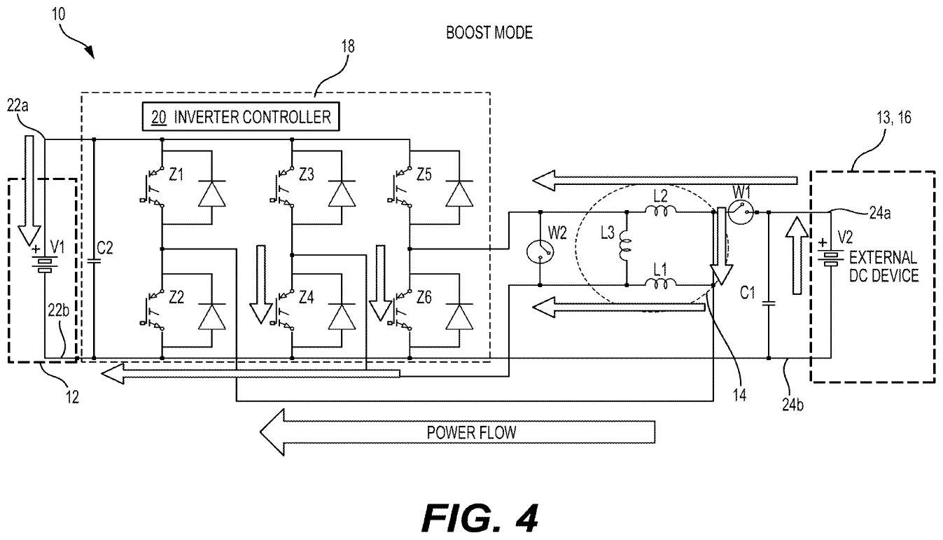

FIG. 3, and FIG. 4 are circuit schematics of the proposed electrical system showing the energy flow in the boost operational mode when the external power source 13, 16 has been connected and the second voltage V2 of the external power source 13, 16 is higher than the first voltage V1 of the onboard energy storage device 12. As a non-limiting example, the external power source 13, 16 may be 400V while the first voltage V1 of the onboard energy storage device 12 may be 800V. In the examples provided inverter controller 20 will control operation of the semiconductor switches Z1-Z6 to implement a boost operating mode between V2 and V1. The inverter controller 20 can utilize parameters to output a pulse-width modulation (PMW) signal to cause one or more inverter switches Z1 to Z6 to operate as further described. In this boost operational mode switch W1 is in a switched to a closed state and maintained to allow current flow from the external voltage source V2 to the rest of the circuit. Semiconductor switches Z1 and Z2 may remain open in a non-current conducting mode. Semiconductor switch pairs Z5 and Z6 and semiconductor switch pairs Z3 and Z4 may be operated using PMW. In the boost mode, the phase balancing switch W2 may be operated in a closed position, allowing current to pass therethrough.

To increase, or step-up, the second voltage V2 from the external power source 13, 16, the inverter controller 20 transitions the semiconductor switches Z3 and Z5 between the closed conducting state (FIG. 3) and the open state (FIG. 4) resulting in electrical system 10 performing a boost conversion where inductor current is decreasing in machine windings L1 and L2 while the DC link capacitor C2 is being charged. This arrangement allows two of the motor windings to be utilized as inductors in the boost conversion, with a third machine winding L3 not being utilized. Alternatively, semiconductor switches Z4 and Z6 transition between the open state (FIG. 3) and the closed conducting state (FIG. 4) resulting in an increase of inductor current in machine windings L1 and L2. The DC link capacitor C2 provides a voltage greater than the first voltage V1, thereby transferring power to the onboard energy storage device 12. energy at an increased voltage to battery voltage V1.

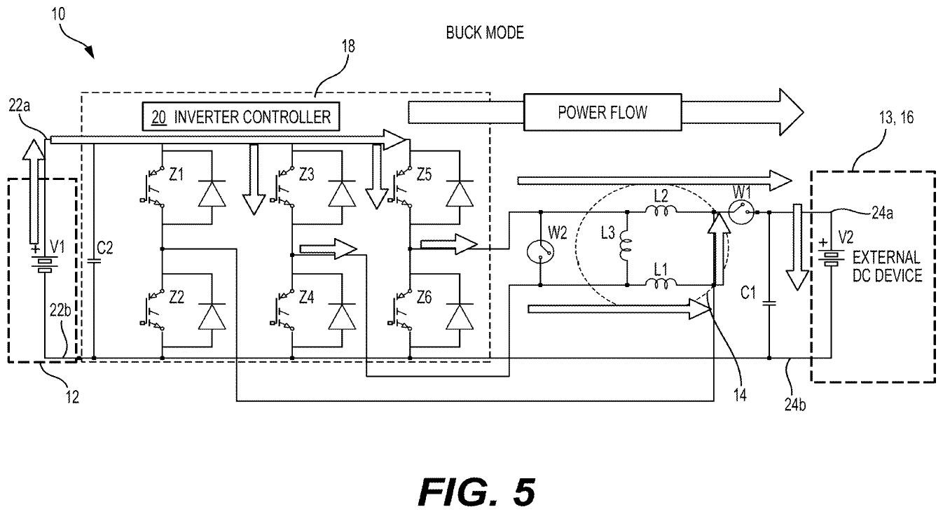

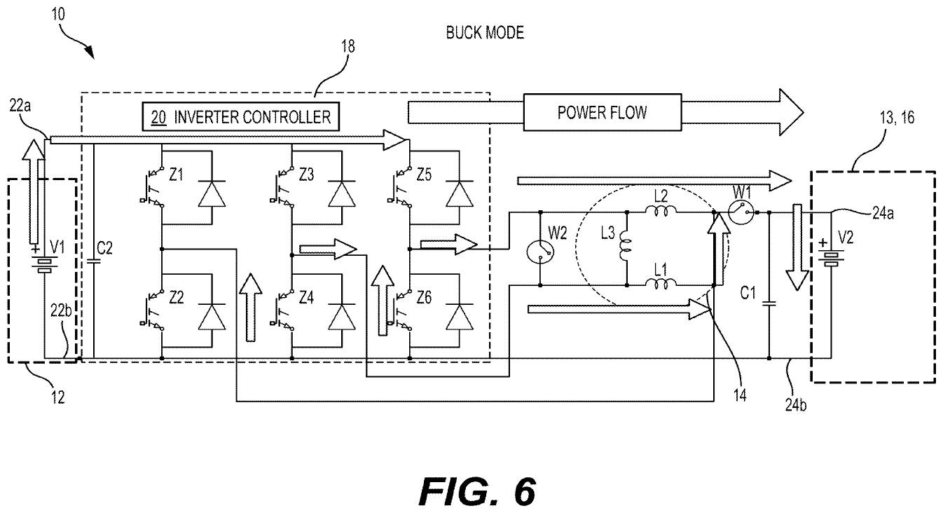

FIG. 5, and FIG. 6 are circuit schematics of the proposed electrical system showing the energy flow in the buck operational mode when the external power source 13, 16 has been connected and defines the second voltage V2 that is lower than the first voltage V1 of the onboard energy storage device 12. As a non-limiting example, the second voltage V2 of the external power source 13, 16 may be 400V while the first voltage V1 of the onboard energy storage device 12 may be 800V. The inverter controller 20 will control operation of the semiconductor switches described to implement an interleaved buck operating mode between the first voltage V1 and the second voltage V2. The inverter controller 20 can utilize parameters to output a PMW signal to cause one or more inverter switches Z1 to Z6 to operate as further described. In this buck operational mode, the mode switch W1 is in a closed state to allow current flow from the onboard energy storage device 12 to the external power source 13, 16 via the semiconductor switched pairs Z3/Z4 and b 5/Z6 and via machine windings L1 and L2. Semiconductor switches Z1 and Z2 may remain open in a non-current conducting mode. Semiconductor switch pairs Z3 and Z4 and semiconductor switch pairs Z5 and Z6 may be PWM operated.

To decrease, or step-down, the first voltage VI for transferring power from the onboard energy storage device 12 to the external power source 13, 16, the inverter controller 20 transitions the semiconductor switches Z3 and Z5 between the closed conducting state (FIG. 5) and the open state (FIG. 6) resulting in electrical system 10 and inductors L1 and L2 performing a buck conversion which can reduce the voltage from the first voltage V1 to the lower second voltage V2. Alternatively, semiconductor switches Z4 and Z6 transition between the open state (FIG. 5) and the closed conducting state (FIG. 6). This arrangement allows two motor windings, L1 and L2, to be utilized as inductors in the buck conversion. Power flows from the onboard energy storage device 12 to the external power source 13, 16 through the interleaved buck converter formed by leg Z3/Z4 and Z5/Z6. The inverter switches work in complementary mode along with the phase windings L1 and L2 to smooth the ripple current. Similar to boost mode, a phase balancing switch (W2) is an optional switch which can be implemented if there is an imbalance in phase windings L1 and L2 during buck mode, connecting two of the winding nodes 26b, 26c of the traction motor 14. In the buck mode, the phase balancing switch W2 may be in a closed position allowing current to pass therethrough.

The mode control switch W1 and the phase balancing switch W2 may be turned off during normal operation, electrical energy is provided by the onboard energy storage device 12 to the traction motor 14, and the states of the mode control switch W1 and the phase balancing switch W2 result in no extra imbalance or asymmetry in the motor windings L1, L2, L3. It is an aspect of the present disclosure to provide an electrical system which can provide complete regulation of the output voltage across all DC voltage ranges. It is an aspect of the present disclosure to provide operation in a bi-directional boost/buck mode.

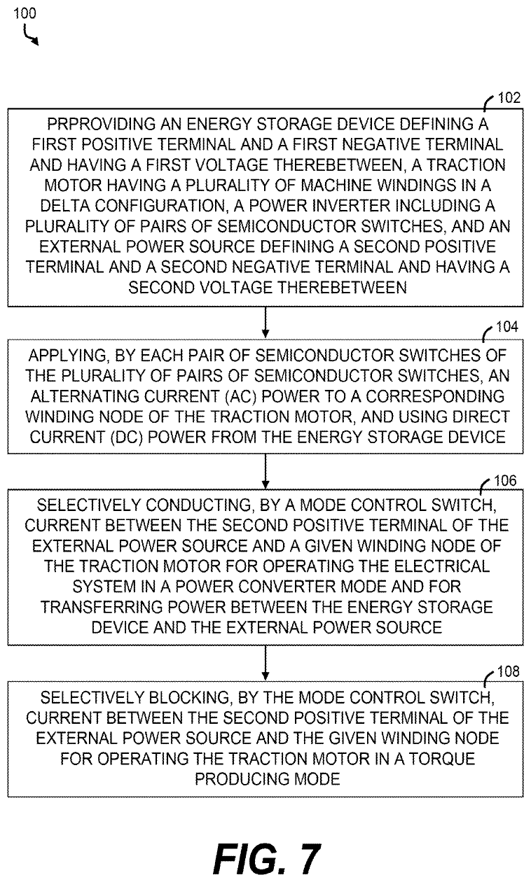

FIG. 7 shows a flow chart illustrating steps in a method 100 of operating an electrical system. As can be appreciated in light of the disclosure, the order of operation within the method is not limited to the sequential execution as illustrated in FIG. 7, but may be performed in one or more varying orders as applicable and in accordance with the present disclosure.

The method 100 includes providing, at step 102, an energy storage device defining a first positive terminal and a first negative terminal and having a first voltage therebetween, a traction motor having a plurality of machine windings in a delta configuration and defining a first winding node, a second winding node, and a third winding node, an inverter including a plurality of pairs of semiconductor switches, and an external power source defining a second positive terminal and a second negative terminal and having a second voltage therebetween. For example, the method 100 may be performed using the electrical system 10 of the present disclosure.

The method 100 also includes applying, at step 104, by each pair of semiconductor switches of the plurality of pairs of semiconductor switches, an alternating current (AC) power to a corresponding one of the first winding node, the second winding node, and the third winding node, and using direct current (DC) power from the energy storage device.

The method 100 also includes selectively conducting, at step 106, and by a mode control switch, current between the second positive terminal of the external power source and a given winding node of the first winding node, the second winding node, and the third winding node for operating the electrical system in a power converter mode for transferring power between the energy storage device and the external power source. For example, the mode control switch W1 may be operated in a conducting mode to conduct AC current between the second positive terminal 24a and the first winding node 26a and to operate to the electrical system 10 in a power converter mode, such as a buck mode or a boost mode, for transferring power between the external power source 13, 16 and the onboard energy storage device 12.

The method 100 also includes selectively blocking, at step 108, by the mode control switch, current between the second positive terminal of the external power source and the given winding node for operating the traction motor in a torque producing mode. For example, the mode control switch W1 may be operated in a non-conducting mode to block current between the second positive terminal 24a and the first winding node 26a and to operate the electrical system 10 in a torque producing mode to energize the traction motor 14 for accelerating the vehicle 11.

In some embodiments, the energy storage device is an onboard energy storage device located on or within a vehicle, and wherein the traction motor is configured to propel the vehicle.

In some embodiments, operating the electrical system in the power converter mode includes operating the electrical system in a boost mode to transfer power from the external power source and to the energy storage device.

In some embodiments, operating the electrical system in the power converter mode includes operating the electrical system in a buck mode to transfer power from the energy storage device and to the external power source.

In some embodiments, the method 100 further includes selectively conducting, by a phase balancing switch, current between two additional winding nodes of the first winding node, the second winding node, and the third winding node, where the two additional winding nodes do not include the given winding node. For example, the phase balancing switch W2 may be selectively actuated to conduct current and to compensate for an imbalance between phase windings L1 and L2 during boost mode.

In some embodiments, the method 100 further includes smoothing a ripple in the second voltage by a capacitor connected between the second positive terminal and the second negative terminal of the external power source. For example, the first capacitor C1 may function to smooth or reduce a ripple in the second voltage between the second positive terminal 24a and the second negative terminal 24b during the buck mode, when power is transferred to the external power source 13, 16.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

What is claimed is:

1. An electrical system, comprising:
an energy storage device defining a first positive terminal and a first negative terminal and having a first voltage therebetween;
a traction motor having a plurality of machine windings in a delta configuration and defining a first winding node, a second winding node, and a third winding node;
an inverter connected to the energy storage device for receiving direct current (DC) power therefrom, the inverter including a plurality of pairs of semiconductor switches, each pair of semiconductor switches of the plurality of pairs of semiconductor switches being configured to apply an alternating current (AC) power to a corresponding one of the first winding node, the second winding node, and the third winding node;
an external power source defining a second positive terminal and a second negative terminal and having a second voltage therebetween; and
a mode control switch connected directly between the second positive terminal of the external power source and a given winding node of the first winding node, the second winding node, and the third winding node, wherein the mode control switch is operable in a closed state to allow current flow therethrough, and wherein the mode control switch is operable in an open state to prevent current flow directly between the external power source and the given winding node.

2. The electrical system of claim 1, wherein the electrical system is configured to cause the mode control switch to be in the open state for operating the inverter to apply the alternating current (AC) power to the plurality of machine windings to cause the traction motor to generate a torque, and wherein the electrical system is configured to cause the mode control switch to be in the closed state for operating the electrical system in a power converter mode to transfer power between the energy storage device and the external power source.

3. The electrical system of claim 2, wherein first voltage of the energy storage device is greater than the second voltage of the external power source, and wherein operating the electrical system in the power converter mode includes operating the electrical system in a boost mode to transfer power from the external power source and to the energy storage device.

4. The electrical system of claim 2, wherein first voltage of the energy storage device is greater than the second voltage of the external power source, and wherein operating the electrical system in the power converter mode includes operating the electrical system in a buck mode to transfer power from the energy storage device and to the external power source.

5. The electrical system of claim 1, wherein the energy storage device is an onboard energy storage device located on or within a vehicle, and wherein the traction motor is configured to propel the vehicle.

6. The electrical system of claim 1, wherein the second voltage of the external power source is substantially lower than the first voltage of the energy storage device.

7. The electrical system of claim 1, further comprising a phase balancing switch configured to selectively conduct current between two additional winding nodes of the first winding node, the second winding node, and the third winding node, wherein the two additional winding nodes do not include the given winding node.

8. The electrical system of claim 1, further comprising a capacitor connected between the second positive terminal and the second negative terminal of the external power source.

9. A method of operating an electrical system, the method comprising:
providing an energy storage device defining a first positive terminal and a first negative terminal and having a first voltage therebetween, a traction motor having a plurality of machine windings in a delta configuration and defining a first winding node, a second winding node, and a third winding node, an inverter including a plurality of pairs of semiconductor switches, and an external power source defining a second positive terminal and a second negative terminal and having a second voltage therebetween;
applying, by each pair of semiconductor switches of the plurality of pairs of semiconductor switches, an alternating current (AC) power to a corresponding one of the first winding node, the second winding node, and the third winding node, and using direct current (DC) power from the energy storage device;
selectively conducting, by a mode control switch, current directly between the second positive terminal of the external power source and a given winding node of the first winding node, the second winding node, and the third winding node for operating the electrical system in a power converter mode for transferring power between the energy storage device and the external power source; and
selectively blocking, by the mode control switch, current between the second positive terminal of the external power source and the given winding node for operating the traction motor in a torque producing mode.

10. The method of claim 9, wherein the energy storage device is an onboard energy storage device located on or within a vehicle, and wherein the traction motor is configured to propel the vehicle.

11. The method of claim 9, wherein operating the electrical system in the power converter mode includes operating the electrical system in a boost mode to transfer power from the external power source and to the energy storage device.

12. The method of claim 9, wherein operating the electrical system in the power converter mode includes operating the electrical system in a buck mode to transfer power from the energy storage device and to the external power source.

13. The method of claim 9, wherein the second voltage of the external power source is substantially lower than the first voltage of the energy storage device.

14. The method of claim 9, further comprising selectively conducting, by a phase balancing switch, current between two additional winding nodes of the first winding node, the second winding node, and the third winding node, wherein the two additional winding nodes do not include the given winding node.

15. The method of claim 9, further comprising smoothing a ripple in the second voltage by a capacitor connected between the second positive terminal and the second negative terminal of the external power source.

16. The electrical system of claim 1, wherein the external power source is a single-phase DC supply.

17. The method of claim 9, wherein the external power source is a single-phase DC supply.
